(19) United States
(12) Patent Application Publication
(10) Pub. No.: US 2005/0094793 A1
(43) Pub. Date: May 5, 2005

(54) System and method for recording a call using a PBX (private branch exchange)

(75) Inventors: Nicholas A. D'Agosto III, Trumbull, CT (US); John Henits, Stratford, CT (US)

Correspondence Address: KELLEY DRYE & WARREN LLP, 1200 19TH STREET, NW, SUITE 500, WASHINGTON, DC, 20036, US

(73) Assignee: Dictaphone Corporation

(21) Appl. No.: 10/697,167

(22) Filed: Oct. 31, 2003

(51) Int. Cl. H04M 1/64; H04M 3/42

(52) U.S. Cl. 379/202.01; 379/67.1

(57) ABSTRACT

A system and method for producing a telephone conference record through a PBX system is provided. The system includes the steps of detecting when the user has called a recorder port, opening a call record and recording a telephone conversation with another party when the user is connected to a recorder port, detecting when the user's telephone line is disconnected, and stop recording and close the call record when the user's telephone line is disconnected. The recorder port is one of a plurality of recorder ports associated with the PBX, and a user's call to a recorder port may be connected with any of the plurality of recorder ports not recording at that time. Alternatively, the user may be associated with a hunt group that is configured to only a distinct subset of the plurality of recorder ports. The user may establish the telephone connection with the other party either prior to calling the recorder port or after calling the recorder port.

### BACKGROUND OF THE INVENTION

The present invention relates generally to a system and method for producing a telephone conference record by connecting using a private branch exchange (PBX).

A PBX is a private telephone network used within an enterprise. Users of the PBX share certain number of outside lines for making telephone calls external to the PBX. Most medium-sized and larger companies use a PBX because it is much less expensive than connecting an external telephone line to every telephone in the organization. Additionally, it is easier to call someone within a PBX because the number that would be needed to be dialed is a typically three or four digit number.

Telephone recording systems have existed for many years. Typically, these recording systems have relied upon individual connections to each telephone that may request recording. For example, a system having one hundred telephones would require one hundred ports and an expensive recording system to achieve recording capability for each telephone line. One example of such a recording system is the Freedom® digital recording system, marketed by Dictaphone Corporation, which utilizes DSC-4 cards (each card containing four ports) to connect telephones with the Freedom® recorder. The obvious disadvantage to this type of recording system is the large number of DSC-4 cards, and possibly a large number of system boards, needed to support a large number of telephone lines.

What is needed is a telephone recording system that utilizes the network functionality of a PBX system to reduce the cost of providing recording capability to a large number of telephone lines.

### SUMMARY OF THE INVENTION

The present invention includes a system and method for producing a telephone conference record through a PBX system. The system includes the steps of detecting when the user has called a recorder port, opening a call record and recording a telephone conversation with another party when the user is connected to a recorder port, detecting when the user's telephone line is disconnected, and stop recording and close the call record when the user's telephone line is disconnected. The recorder port is one of a plurality of recorder ports associated with the PBX, and a user's call to a recorder port may be connected with any of the plurality of recorder ports not recording at that time. Alternatively, the user may be associated with a hunt group that is configured to only a distinct subset of the plurality of recorder ports. The user may establish the telephone connection with the other party either prior to calling the recorder port or after calling the recorder port using the conference capability of the PBX.

In some embodiments, the present invention includes capturing the calling line identification associated with the user if the user has called a recorder port. In this embodiment, the user may call another party prior to calling the recorder port or the user may call another party after calling the recorder port.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 depicts a flow diagram illustrating the steps for opening a call record in accordance with certain teachings of the present disclosure;

FIG. 2 depicts a flow diagram illustrating the steps for closing a call record in accordance with certain teachings of the present disclosure;

FIG. 3 shows a system diagram for a first method of using a PBX system utilizing the teachings of the present disclosure; and

FIG. 4 shows a system diagram for a second method of using a PBX system utilizing the teachings of the present disclosure.

### DETAILED DESCRIPTION OF THE PREFERRED EMBODIMENTS

The present disclosure will now be described more fully with reference the to the Figures in which an embodiment of the present disclosure is shown. The subject matter of this disclosure may, however, be embodied in many different forms and should not be construed as being limited to the embodiments set forth herein.

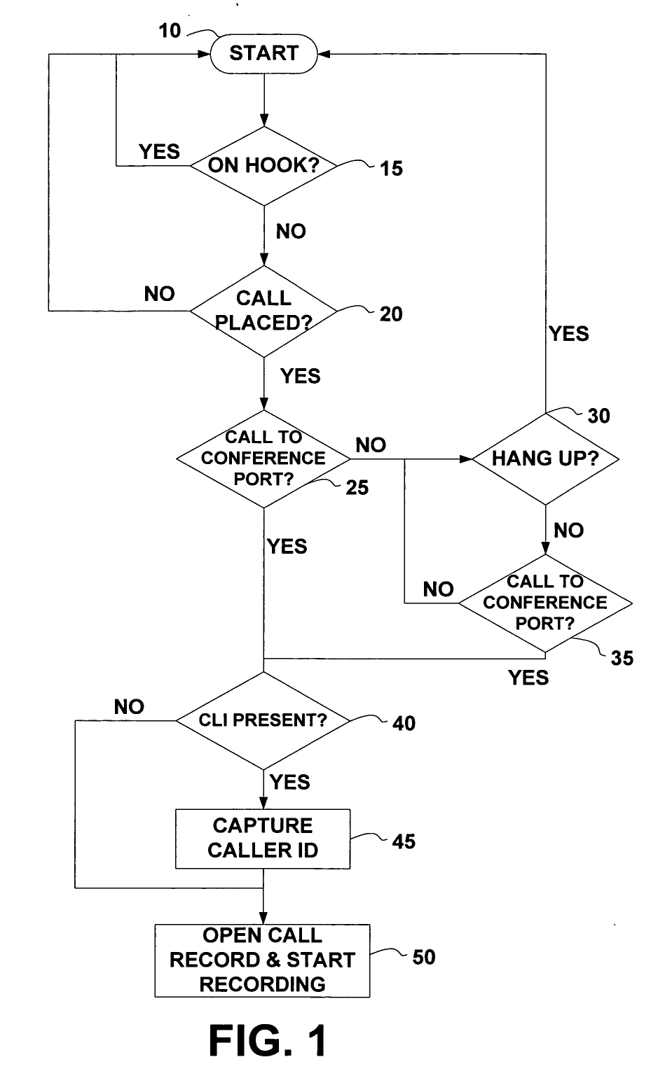

Referring to FIG. 1, which shows a flow diagram illustrating the steps for opening a call record in accordance with certain teachings of the present disclosure. Beginning at the Start symbol 10, the system remains in loop 15 as long as the user is on the telephone. If the user is not using the telephone, the system remains in loop 20 until a call is placed. Once a call has been placed, the system determines in block 25 whether the call was placed to a recorder port in the PBX. If the call was not placed to a recorder port, the system will remain in loop 30 until the user either hangs up, at which time the system will return to Start 10 and loop 15, or the user places a separate call to a recorder port in the PBX as illustrated by block 35. If a call is placed to a recorder port in the PBX in either blocks 25 or 35, the system in block 40 then determines whether the calling line identification (CLI) is presented to the PBX. If the CLI is presented, the system captures that CLI information on the caller ID in box 45. Whether the CLI is presented or not, the system then begins recording the telephone conversation and opens a call record (Block 50).

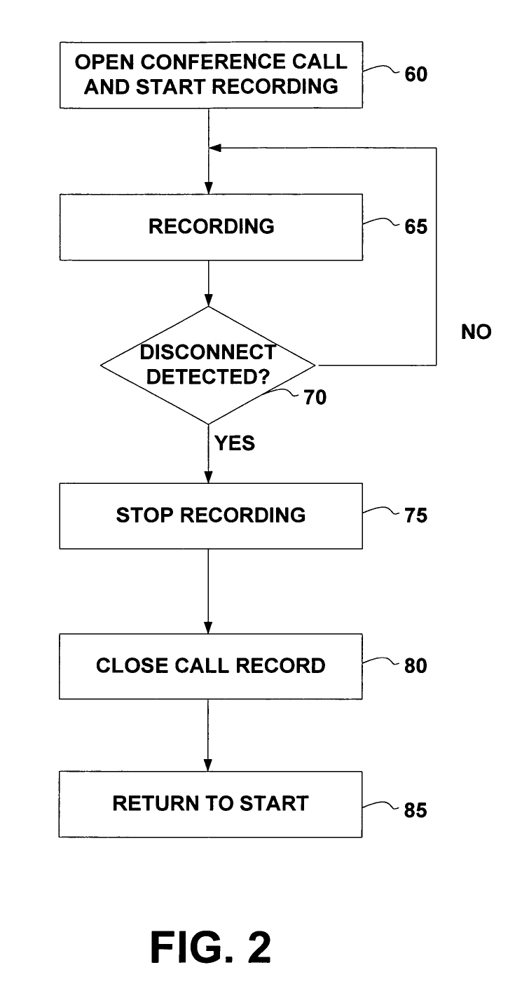

Referring to FIG. 2, which shows a flow diagram illustrating the steps for closing a call record in accordance with certain teachings of the present disclosure. Beginning with an open call that is being recorded at block 60, the system determines at block 70 whether the telephone call is still connected, and continues recording in loop 65 until a disconnect is detected. Once a disconnect is detected in block 70, the recording is stopped in block 75 and the call record is closed in block 80. The system then returns to the Start in block 85, which corresponds to the Start symbol 10 in FIG. 1.

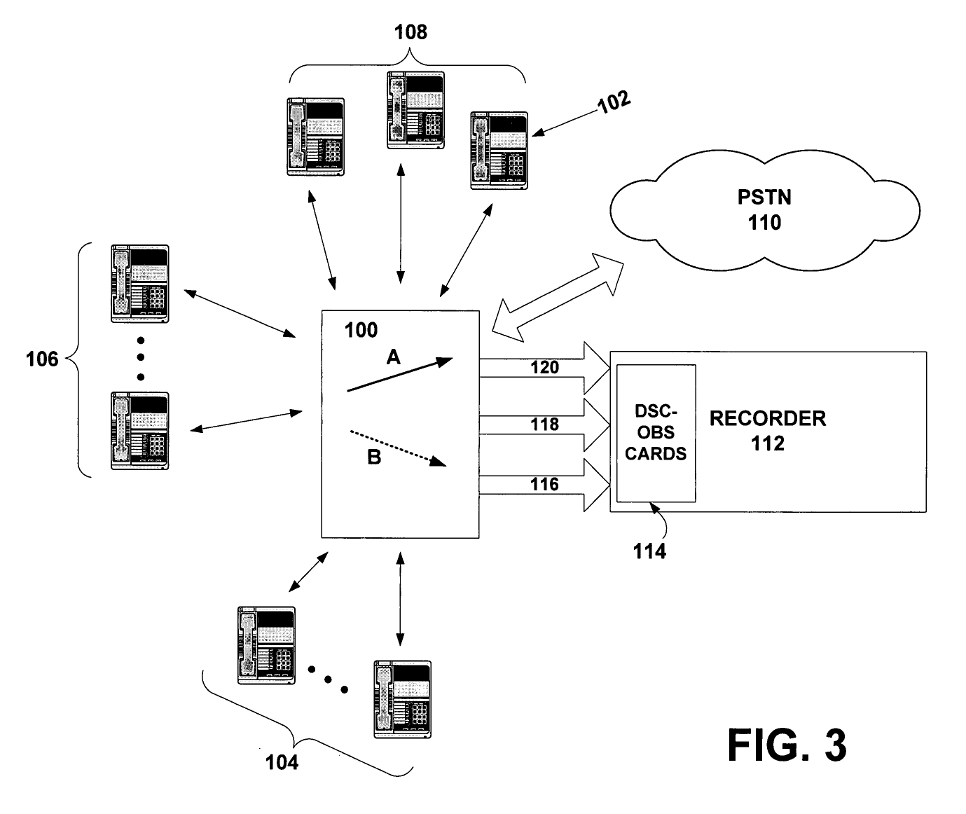

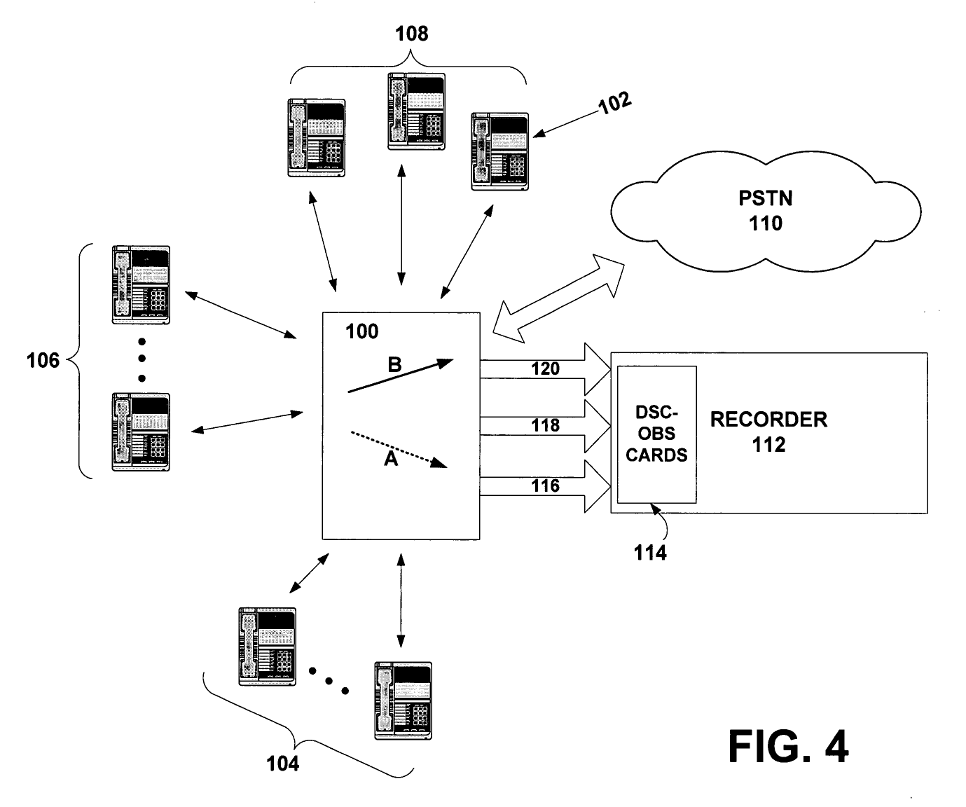

The flow diagrams of FIGS. 1 and 2 may be utilized with a PBX system as illustrated with reference to FIGS. 3-4. Referring to FIG. 3 shows a system diagram for one illustrative embodiment of a PBX system utilizing the teachings of the present disclosure. PBX 100 is shown in FIG. 3 connected to a large number of users 102. In the illustrative embodiment shown in FIG. 3, users 102 are divided into groups 104, 106, and 108. In a PBX servicing a corporation, users 102 are likely the employees of the corporation and groups 102, 104, and 106 may be, for example, a sales group, the legal department, and a group consisting of miscellaneous users. The public switched telephone network (PSTN) 110 is also shown in the system as this is the means for users 102 to make outside calls, such as is commonly done in most PBX systems by dialing 9 to gain an outside line.

The recorder 112 is physically similar to a typical recorder found in the prior art, except that instead of using a single DSC-4 card to individually link four telephone lines with four recording ports, a single DSC-OBS card 114 is used to connect four recorder ports to the PBX 100. As in traditional recording systems, multiple DSC-OBS cards installed within the recorder 112 provides more recorder ports. Unlike traditional recorders, however, the system described by the present disclosure is statistically-based. In this type of system, there are fewer RECORDER ports than there are users 102. If there is not a recorder port available when a user wishes to record a telephone call, then the call cannot be recorded and PBX returns a busy signal. Since the present disclosure describes a shared recording resource, a key to its practical success is the statistical grade of service desired. For example, if the system administrator determines that only 10% of the users 112 would require simultaneous recording, then one number of recorder ports that a system administrator may choose for such a system would be 10% of the number of users 112. This is a key advantage over prior art systems, which requires each potential user to be hard-wired into a recording port on a DSC-4 card, thereby adding the complexity and cost of the telephone recording system.

Another feature of the present disclosure that provides better manageability of the shared recording resources discussed above are hunt groups 116, 118, and 120. Hunt groups are useful for isolating specific user groups that may have well-defined or specific recording requirements, routing those recording requests into dedicated recorder ports for that particular hunt group. For example, user group 104 may have their own hunt group 116, user group 106 may have their own hunt group 118, and so on. Alternatively, all users 102 may be a part of a single hunt group if no segregation is warranted. Each hunt group could be configured to a single recorder port or a specified number of recorder ports as required by the number of expected simultaneous users in that hunt group.

The primary difference between the DSC-OBS card 114 of the present disclosure and the prior art DSC-4 card lies in its functionality. Unlike a DSC-4 card, each DSC-OBS card functions like a telephone in that when it receives a call from the PBX 100, it answers through a recorder port and opens up a call record (as shown in FIG. 1 with respect to block 50). For example, as illustrated by arrow A in FIG. 3, a user in group 106 would first place a call to an outside phone number by establishing a connection with PSTN 110. During this phone call, the user decides that the call should be recorded. As illustrated by arrow B (and as described in FIG. 1 with respect to blocks 25 and 35), the user then calls a DSC-OBS recorder port to initiate recording the original telephone call. The conferencing step with the DSC-OBS port depends on the user's PBX system and the features that are supported. One embodiment of this step would consist of the user hitting a “conference key” on the user's telephone, then dialing the conference recorder's phone number or extension, and then pressing the conference key again to continue the original conversation while the call is then recorded. In this embodiment, the outside party will be placed on hold as the recorder port connection is established, which is not consistent with a confidential recording. As described with respect to FIG. 2, once the user's phone call with the outside party is disconnected, the recording is automatically stopped, the record file is closed, and the recorder port is then available for the next user that dials into the recording system. The conferencing process described above is consistent with a true “Conference Mode” of operation as can be found, for example, on Lucent/Avaya and Nortel Meridian PBX systems.

As an alternative method of use, FIG. 4 shows the steps needed to create a confidential recording. Essentially, the arrowed steps of FIG. 3 are reversed. First, the user establishes a connection with a recorder port by dialing the conference recorder's phone number or extension (arrow A), and then executes the conferencing steps needed to add the outside party to line for a recorded conversation (arrow B). Note that using this procedure produces no audible indication to the outside party that a recorded call has been set up.

It is also envisioned that the conferencing step described above can be executed by any other means for establishing a conference call using the exact same system of FIG. 3. For example, Lucent/Avaya PBX systems typically offer a “Malicious Call Trace” mode (MCT). For MCT operation, the user would depress the pre-programmed “MCT” key on the telephone that automatically connects the phone to a DSC-OBS port and begins recording. In this mode, the conference record is not disconnected at the hang-up, but rather is disconnected when the user presses a pre-programmed “MCT Release” key on the phone. This mode provides a confidential recording since no audible indication is made that the recording has been established. Nortel Meridian also currently provides a “No Hold Conference” mode which, when utilized with the teachings of the present disclosure, would automatically connect the telephone line to a DSC-OBS port when the pre-programmed “No Hold Conference” key is pressed on the telephone, and automatically disconnects upon hang-up. For these two examples as well as with any other conferencing features on PBX systems, the function and telephone number of the DSC-OBS recorder port must be pre-programmed into spare keys on the telephone by the user's system administrator.

Another advantage of the present disclosure over the prior art recording systems is the ability to record a conversation from a telephone outside of the PBX system. For example, a user working at home could dial the telephone number for the conference recorder and set up a conference with another outside party to create a call record.

As discussed above, one drawback of the system of the present disclosure occurs when the number of calls into the conference recorder exceeds the number of ports configured to a specific hunt group. In one embodiment of the present disclosure, the user will receive a busy signal in such event and will be unable to record the desired telephone call. However, an advantage of the present disclosure lies in the inherent control by the system administrator to create an overflow configuration that would allow the additional calls from a hunt group to connect to a recorder port assigned to another hunt group. In any event, the maximum number of simultaneous recordings is ultimately limited by the number of DSC-OBS cards and thus the number of recorder ports available in a particular recording system.

Yet another advantage of the present disclosure is the possibility of DSC-OBS cards as described in the present disclosure coexisting with DSC-4 cards of the prior art on the same chassis. In other words, certain users or user groups may require “hard-wired” recording capability so that there is never a risk of failure to record a telephone call. Such a situation may exist, for example, with users that are call service agents, where it is common practice to record every telephone call. It is envisioned that DSC-OBS cards and DSC-4 cards are substantially similar in physical dimension and in connection requirements, thus ensuring this interchangeability with prior art technology.

It will be apparent to one of skill in the art that described herein is a novel system and method for producing a telephone conference record. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A system and method for producing a telephone conference record, the method comprising the steps of:
detecting when the user has called a recorder port;
opening a call record and recording the telephone call when the user is connected to a recorder port;
detecting when the user's telephone line is disconnected; and
stop recording and close the call record if the user's telephone line is disconnected.

2. The system and method of claim 1, further comprising capturing the calling line identification associated with the user if the user has called a recorder port.

3. The system and method of claim 1, wherein the user calls another party prior to calling the recorder port.

4. The system and method of claim 1, wherein the user calls another party after calling the recorder port.

5. The system and method of claim 1, wherein the recorder port is associated with a PBX.

6. The system and method of claim 5, wherein the user is associated with the PBX.

7. The system and method of claim 5, wherein the recorder port is one of a plurality of recorder ports associated with the PBX, and wherein the call to a recorder port may be connected with any of the plurality of recorder ports not recording at that time.

8. The system and method of claim 7, wherein the user is associated with a hunt group that is configured to only a distinct subset of the plurality of recorder ports.
